(19) United States
(12) Patent Application Publication
(10) Pub. No.: US 2008/0282181 A1
(43) Pub. Date: Nov. 13, 2008

(54) Executable Application Configuration Information Processing System

(75) Inventor: John Garman Ferguson, Downingtown, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/742,707

(22) Filed: May 1, 2007

Related U.S. Application Data
(60) Provisional application No. 60/796,908, filed on May 2, 2006.

(51) Int. Cl. G06F 3/048

(52) U.S. Cl. 715/771

(57) ABSTRACT

A system provides information indicating a change in configuration of an executable application. An acquisition processor acquires adaptation information identifying a change of a first configuration of a first executable application relative to a second configuration of the first executable application. A data processor associates an adaptation indicator representing a type of change in configuration of the first executable application identified by acquired adaptation information. A user interface provides data representing a display image associated with the first configuration of the first executable application and includes the adaptation indicator.

This is a non-provisional application of provisional application Ser. No. 60/796,908 by J. G. Ferguson filed May 2, 2006.

### FIELD OF THE INVENTION

The present invention relates to a system for processing configuration information in an executable application, and in particular to systems processing configuration information for troubleshooting purposes.

### BACKGROUND OF THE INVENTION

Executable applications use configuration information or adaptation information, to define and/or control the operation of an executable application. For example, some executable applications are intended to be used concurrently by more than one person. Each person may use the executable application in a different configuration. The different configurations may be defined or selected by the respective users, and/or the users may be assigned respective configurations. Configurations assigned to the respective users may be based on the identity of, or function performed by, the user or based on information and/or procedures which the user is permitted to access. Further, different executable applications save the corresponding adaptation information in different places and in different formats.

For example, in a healthcare enterprise environment, information concerning the operation of the healthcare enterprise may be maintained in a database and made available to users by a database management executable application. Some information in the database is made available to a limited number of users. For example, access to clinical information related to a patient may be restricted to the patient's physician, to nursing staff assigned to care for the patient, and to laboratory personnel responsible for performing testing on the patient. Access to financial information related to the patient may be restricted to staff responsible for obtaining payment for medical services rendered to the patient. Thus, access of a user to particular types of data is dependant on the identity of and function performed by the user. The configuration of the database management executable application when used by a physician, therefore, is different from the configuration of the database management executable application when used by insurance reimbursement processing staff. Adaptation information is stored, representing the respective configurations of the database management executable application, corresponding to the respective users and specifying which data and/or procedures are available to that user.

When a user begins use of the database management executable application, the configuration data associated with that user is retrieved. The database management executable application may restrict access of the user to data and/or procedures which the user is permitted to view and execute based on the configuration data representing the user identity and/or function. However, sometimes the operation of the executable application does not seem proper to a user. Continuing the healthcare enterprise example, a user may primarily access the database management at a first location in the healthcare enterprise, implying one function, for example at a nursing station. The database management executable application applies a first configuration for the user and allows access by the user.

But the user may then access the database at a second location implying a different function. The executable application may apply a second configuration at the second location for the user, and this second configuration may be different than the expected first configuration, possibly leading the user to conclude that an error has been made. Typically, there is no information presented to the user as to why the executable application is not behaving as expected; i.e. why data is not being displayed, or expected actions are not being permitted. In any event, the user may be forbidden from doing the required task, or denied access to required data.

In such a situation, the user may contact the technical support group responsible for maintaining the executable application to report an error. That group must begin to troubleshoot the source of the problem. Such troubleshooting typically includes attempting to determine what configuration data was applicable at the time the error occurred. For multiple different executable applications, this entails knowing how to operate and troubleshoot the different executable applications, how to find and decipher the stored adaptation information representing the configuration data used by the different executable applications, and how to associate the configuration data to the problem faced by the user. This also requires that the user contact the support staff to report the problem.

A system is desirable which permits users to determine whether the configuration under which they are using the executable application is the expected configuration. Such a system would permit the user to re-access the executable application to permit operation under the expected configuration, and would minimize calls to the technical support group. Further a system which would permit a technical support group to easily access and analyze configuration data for a group of executable applications, and to be automatically notified of a problem is desirable.

### BRIEF SUMMARY OF THE INVENTION

In accordance with principles of the present invention, a system provides information indicating a change in configuration of an executable application. An acquisition processor acquires adaptation information identifying a change of a first configuration of a first executable application relative to a second configuration of the first executable application. A data processor associates an adaptation indicator representing a type of change in configuration of the first executable application identified by acquired adaptation information. A user interface provides data representing a display image associated with the first configuration of the first executable application and includes the adaptation indicator.

### BRIEF DESCRIPTION OF THE DRAWING

In the drawing:

FIG. 1 is a block diagram illustrating a system for providing information indicating a change in configuration of an executable application according to principles of the present invention; and

FIG. 2 is a more detailed block diagram illustrating a system for providing information indicating a change in configuration of an executable application according to principles of the present invention;

FIG. 3 is a listing in XML format of adaptability information used by the system of FIG. 1 in accordance with the present invention; and

FIG. 4, FIG. 5 and FIG. 6 display respective images of exemplary user interface (UI) forms which may be generated during the operation of the system illustrated in FIG. 1 according to the present invention.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, configuration analysis system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

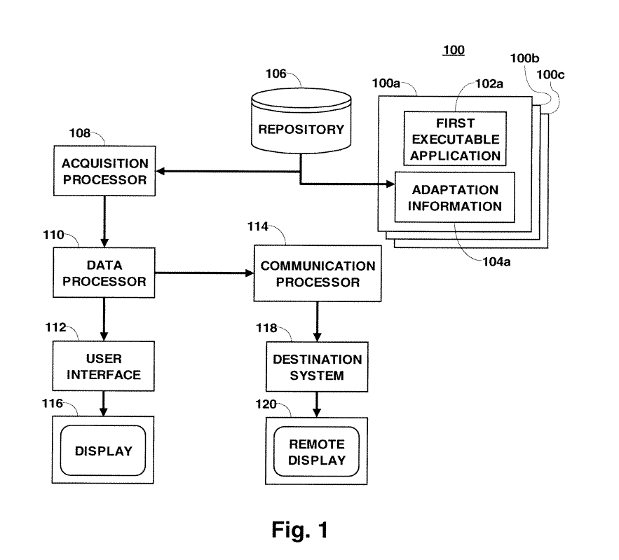

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device. The activities performed by the functions of FIG. 1 herein may be performed automatically or wholly or partially in response to user command. An automatically performed activity is performed in response to machine instruction or operation without direct user interaction in initiating the activity.

A form, as used herein, is a type of UI display image. A form UI display image includes display elements, such as textual display, which prompt the user to enter particular information; and display elements, such as text boxes, check boxes etc., into which the user, using the input devices, may enter the particular information.

Adaptation information as used herein comprises generated adaptation information associated with executable code or executable schema (mechanism for describing results of execution such as a rule clause language) and also comprises executive adaptation information associated with a profile, cfg (configuration) property, or ini file which do not describe an executable element in an application, but rather specify the settings the executable elements use to guide their behavior. Adaptation information includes configuration information identifying executable application settings or parameters that may be altered to adjust application function or operation.

FIG. 1 is a block diagram illustrating a system for providing information indicating a change in configuration of an executable application according to principles of the present invention. In FIG. 1, data representing a plurality 100 of executable applications 100a, 100b, 100c, include respective data representing the executable applications 102a and adaptation information 104a. The adaptation information 104a represents a configuration under which the executable application is operating. One skilled in the art understands that one set of adaptation information exists for each user concurrently using the executable application, defining the configuration of the executable application for that user. One skilled in the art further understands that a user may have more than one set of adaptation information associated with him applicable at different times and/or in different circumstances. A repository 106 stores respective sets of adaptation information for the respective users, and supplies adaptation information to the plurality 100 of executable applications, and to an acquisition processor 108. The acquisition processor is coupled to a data processor 110. The data processor 110 is coupled to a user interface 112 and a communications processor 114. The user interface 112 is coupled to a display device 116. The communications processor 114 is coupled to a destination system 118. The destination system 118 is coupled to a remote display device 120.

In general operation, the acquisition processor 108 acquires adaptation information identifying a change of a first configuration of the first executable application 100a relative to a second configuration of the first executable application 100a. In one embodiment, the acquisition processor 108 acquires the adaptation information 104a from the memory of the executable application 100a. In another embodiment, at least one repository 106 stores the adaptation information for the users for the one or more executable applications 100. In this embodiment, the acquisition processor 108 acquires the adaptation information from the at least one repository 106. This information is stored in the repository 106 in an advantageously standardized adaptation information format.

In one embodiment, the adaptation information identifies a change in configuration of the first executable application 100a resulting from interaction of the second configuration of the first executable application 100a with other ones 100b, 100c of the plurality 100 of executable applications exclusive of configuration changes made by a user during a current operational session of computer operation employing said first configuration of the first executable application 100a. Similarly, the adaptation information may identify a change in configuration of one or more different executable applications relative to a first configuration.

The data processor 110 associates an adaptation indicator, representing a type of change in configuration of the first executable application identified by the acquired adaptation information. The user interface provides data representing a display image associated with the first configuration of the first executable application, and including the adaptation indicator.

The user interface 112 provides data representing a display image indicating differences or changes in configuration between the first and second configurations of the first executable application in response to a user command. This display representative data is provided to the display device 116 which displays the display image. More specifically, the display representative data may be supplied to the display device 116 in response to the user using a graphical user interface (GUI) to select the adaptation indicator contained in the display image.

The display image may include a message indicating a category or type of change in configuration of the first executable application. The category of change in configuration of the first executable application may include: (a) a change in configuration settings of a workflow, (b) a change in configuration setting of data processed in a workflow; and/or (c) a change in configuration settings of a function. More specifically, the user interface 112 may display a selectable dialog menu indicating the current categories of change in configuration. The selectable dialog menu includes entries representing: (a) a change in configuration settings of a workflow; (b) a change in configuration settings of data processed by the workflow; and/or (c) a change in configuration settings of a function. The user interface 112, thus, displays a message indicating a category of change in configuration of the first executable application by use of the selectable dialog menu. In addition, the user interface 112 may generate data representing an image of an informational message indicating that no workflow, data or function adaptations are in effect.

The communications processor 114 automatically communicates configuration information identifying configuration settings of the first configuration of the first executable application to the destination system 118 in response to the generation of a problem report. More specifically, the communications processor 114 automatically communicates adaptation information identifying a change of the first configuration of the first executable application relative to the second configuration of the first executable application. The communications processor 114 further communicates data indicating a problem identified by a user concerning operation of the first configuration of the first executable application to the destination system 118 in response to the generation of the problem report. Generation of the problem report may be initiated by the user when it is realized that the executable application is not behaving as expected, or may be generated automatically.

The communications processor 114 communicates information indicating a desired configuration setting of the first executable application to the destination system 118. This information may be communicated in response to a user command. More specifically, the remote display device 120 displays a display image indicating available different configuration settings. The desired configuration setting is selected from the display image on the remote display device 120 indicating differences in configuration by a user command.

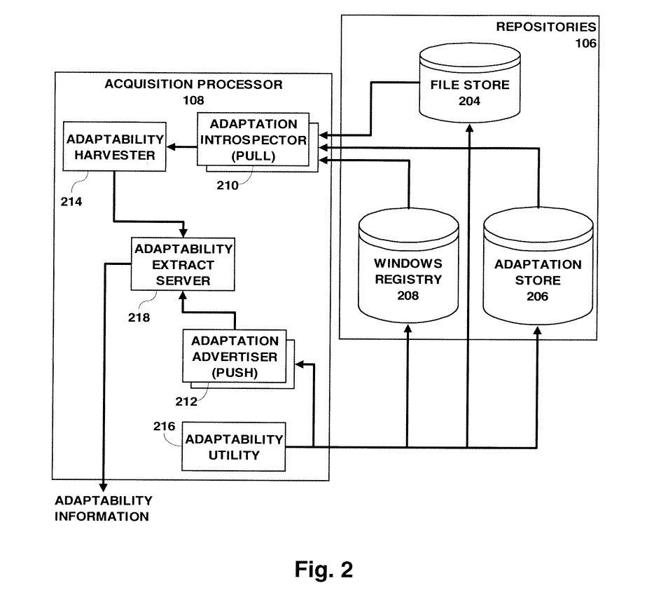

FIG. 2 is a more detailed block diagram illustrating a system for providing information indicating a change in configuration of an executable application according to principles of the present invention. In FIG. 2, data representing adaptation information is stored in repositories 106. This data may be stored in different forms in different locations and on different devices. In the illustrated embodiment, a first repository 204 resides in a mass storage device connected to a processor in the system. A second repository 206 resides in a mass storage device dedicated to containing adaptation information. This repository may be located locally in the workstation or may reside at a central server. A third repository 208 represents a collection of data for the Windows operating system called the registry. A copy of the registry is maintained in the read-write memory of a processor executing the Windows operating system, and this data is written to a mass storage device associated with that computer. These mass storage devices may be a hard disk drive or other similar non-volatile memory in a client or host computer system, for example.

Data is acquired from the repositories 106 by the acquisition processor 108. An adaptation introspector 210 extracts adaptation information from the repositories 106 when required. This operation is termed a pull. Because different executable applications may store adaptation information in different formats, a plurality of adaptation introspectors 210 may be implemented for accessing the adaptation information of the respective executable applications. In this manner, as an executable application is added to the system, an adaptation introspector 210 may be added to acquire adaptation information used by that executable application. An adaptability harvester 214 operates to determine the adaptation introspectors 210 which are available and to activate them to acquire adaptation information for the executable applications they are associated with. The adaptation harvester supplies the adaptation information in a standardized format to an adaptability extract server 218, which makes that information available to other executable procedures, such as the data processor 110 illustrated in FIG. 1. For example, the adaptation information may be formatted into an extensible markup language (XML) format.

An adaptation advertiser 212 monitors adaptation information as it is supplied to the repositories 106. This operation is termed a push. For example, an adaptation utility 216 receives adaptation information from a user and supplies that information to the repositories 106. Concurrently, the adaptation utility 216 supplies that information to the adaptation advertiser 212. The adaptation advertiser 212 supplies the adaptation information to the adaptability extract server 218 in the standardized, e.g. XML, format. In an acquisition processor 108 an adaptation introspector 210, an adaptation advertiser 212, or both, may be available. The adaptability extract server 218, in turn, provides adaptation information to other executable procedures in the standardized, e.g. XML format.

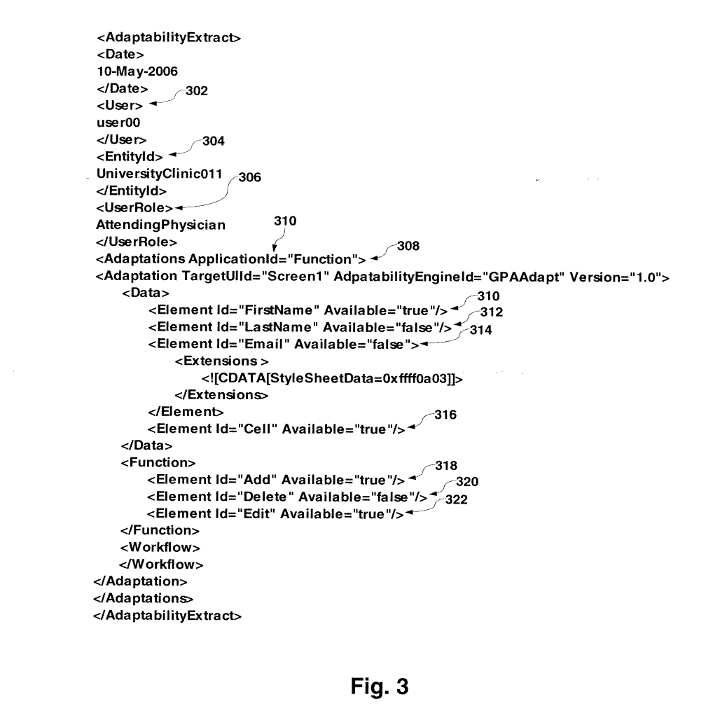

FIG. 3 is a listing in XML format of adaptability information used by the system of FIG. 1 in accordance with the present invention. In FIG. 3, an adaptability extract XML listing contains adaptability information for a user of an executable application. Information relating to the identity of the user is contained in a <User> block 302; information relating to the identity of the entity associated with the user is contained in a <EntityID> block 304; and information relating to the role of the user is contained in a <UserRole> block 306. This enables different configurations to be assigned on the basis of which entity a user is associated with, and what role the user is assuming, at the time. An <Adaptations> block 308 contains a plurality of sets of adaptation information for respective executable applications, each identified by an ApplicationID 310. Each <Adaptations> block contains a plurality of <Adaptation> blocks for respective user interface (UI) screens which that user is able to access in the identified executable application.

In the embodiment illustrated in FIG. 3, there are three types of adaptation information: data; function; and workflow. Data adaptation information defines which data the user may see in their current entity and role. For example, a physician may see a patients clinical data, while a file clerk cannot. Function adaptation information defines which functions a user may perform in their current entity and role. For example, a file clerk may add and/or delete a patient record, while a physician may not. Workflow adaptation information defines sequences of UIs used to perform a flow of work which a user may perform in their current entity and role. For example, a laboratory technician may have access to a workflow for performing and recording the results of a series of laboratory tests ordered for a patient, while a file clerk may not.

In FIG. 3, the user ‘user00’ working for the ‘UniversityClinic011’ as an ‘AttendingPhysician’ includes adaptation information for application ‘Function’. For the UI ‘Screen1’ the user may see the data elements ‘FirstName’ (310) and ‘Cell’ (316), but not the data elements ‘LastName’ (312) or ‘Email’ (314). Similarly, the user may perform the ‘Add’ (318) and ‘Edit’ (322) functions, but not the ‘Delete’ (320) function. Workflow adaptation information is not provided for this UI screen, so any workflows available on this UI screen are available to the user. These adaptations are reflected as changes in the UI image displayed for the user when using the system and displaying this UI screen.

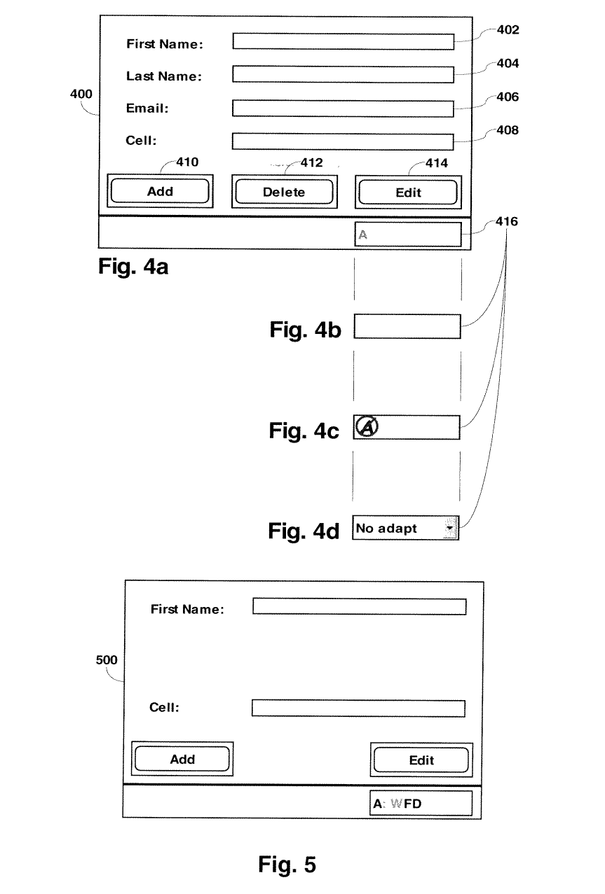

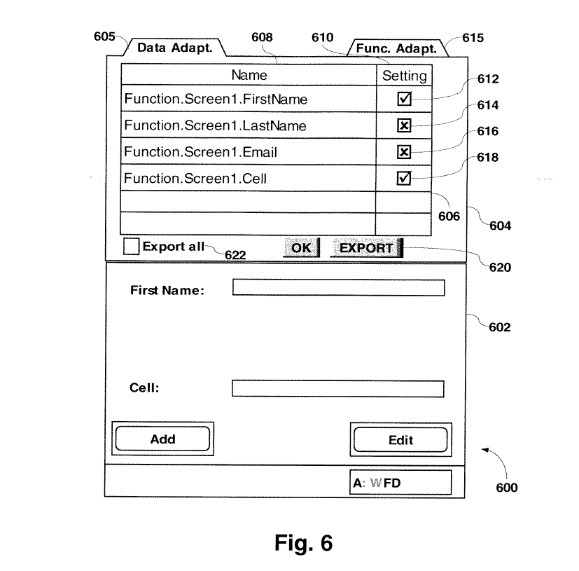

FIG. 4 displays an image of an exemplary user interface (UI) form 400 which may be displayed during the operation of the system illustrated in FIG. 1 according to the present invention. The form 400 includes four data fields: ‘First Name’ 402, ‘Last Name’ 404, ‘Email’ 406 and ‘Cell’ 408. The form 400 further includes three buttons to perform respective functions: ‘Add’ 410, ‘Delete’ 412 and ‘Edit’ 414. No workflow related UI elements are shown to simplify the figure. Such workflow elements may include “Next” and/or “Prev” buttons to display respective next or previous UI forms in a sequence for a user, or other elements to display a desired UI form in a sequence for a user.

However, the user ‘user00’ is assigned the adaptability information illustrated in FIG. 3 and described above, and does not have access to all the data and functions. Instead, a form 500 as illustrated in FIG. 5 is displayed. In form 500, the ‘Last Name’ and ‘Email’ fields are not displayed because the user user00 is not authorized to see this information. In addition, the button for the ‘Delete’ function is not displayed because the user use00 is not authorized to perform this function. If the user user00 is generally permitted to see the omitted data ‘Last Name’ and ‘Email’ and the omitted function ‘Delete’, that user may see this as a problem and contact technical support to report the problem.

Referring back to FIG. 1, the data processor 110 receives the adaptation information from the acquisition processor 108 in the standardized, e.g. XML, format. As described above, when a user begins to use an executable application, a configuration is provided for that user represented by configuration data from a repository 106. This configuration may be different for the same user at different times, locations, etc. The data processor 110 is able to compare a change from a first configuration of a first executable application, represented by data from the repository 106 to a second configuration of the first executable application. The differences in the first and second configurations may provide a reason for what a user perceives as a problem.

The data processor 110 provides data to the user interface 112 representing the change between the first and second configurations of the first executable application. The user interface 112, in turn, generates data representing an adaptation indicator identifying a type of change of configuration. Referring back to FIG. 4, the adaptation indicator image representing these changes is illustrated as element 416 in the status bar at the bottom of the form 400. The adaptation indicator provides a way for the user to know what, if any, adaptations are in force in the current configuration. Knowing this information may provide the user with enough information to understand the source of a problem in accessing data, functions and/or workflow. In FIG. 4a, the display of the adaptation indicator image includes a letter “A” in status bar 416 which is grayed out. This is to indicate that no adaptation changes are active, and all data, functions and workflows are available. Other alternative adaptation indicator display images may be used: for example, the adaptation indicator display image may be left blank to indicate that no adaptation changes are active, as illustrated in FIG. 4b; or it may be an icon instead of text, as illustrated in FIG. 4c. In FIG. 4c, the icon is a stylized “A” with a slashed circle to indicate that no adaptation changes are active. One skilled in the art understands that any icon, symbol, text or attribute may be used, preferably one which suggests that no adaptation changes are active. In yet another alternative, a drop-down text box displaying text describing the current adaptation changes which are active may be used, as illustrated in FIG. 4d. One skilled in the art understands that any similar such adaptation indicator display image may be used and that the adaptation indicator display may be located in other locations on the display device 116. For example, the adaptation indicator display may be located in the title bar of the executable application window; or on what is known as the task bar, or in the System Notification Area, of a Microsoft Windows based workstation; or may be displayed in a separate window or dialog box.

Referring again to FIG. 5, as described above, adaptation information for the user, entity and role specifies changes in data and function access. Consequently, the adaptation indicator display in FIG. 5 displays an “A” which is not grayed-out, but is now bold. This indicates that adaptation changes are active. The bold letter “A” is followed by a grayed-out letter “W” to indicate that no workflow adaptation changes are active. However, a bold letter “F” and bold letter “D” are displayed to indicate that function and data adaptation changes are active, and account for the display of the form 500. The adaptation display indicator displays of FIGS. 4b, c and d are similarly modified in a corresponding appropriate manner to indicate such adaptation information changes.

Should a user feel that information they usually see, functions they usually can perform, or workflows they usually can follow are not available, the adaptation display indicator can provide information indicating that it is the configuration of the executable application which is controlling the lack of access to usually available UI elements. More information may be provided to the user. A means for accessing this further information may be provided to the user, for example, double clicking on the adaptation display indicator, or other such access method.

FIG. 6 illustrates a UI form 600 providing a user more information about adaptation information relating to the current configuration of the current executable application. A lower portion 602 of form 600 is a copy of the displayed UI form 500 (FIG. 5) which displayed for the user. The upper portion 604 of form 600 displays adaptation information currently active for the user. Portion 604 includes two tabs. A first tab 605 displays adaptation information relating to data availability and a second tab 615 displays adaptation information related to function availability. Further tabs may be added to represent other types of adaptation information such as workflow adaptation information.

In portion 604 a table 606 contains respective rows representing the data available for display in the UI form 400 (FIG. 4). A first column 608 describes the data, a second column 610 specifies whether that data is available to a user in this configuration. In the illustrated embodiment, the second column includes a plurality of check boxes in which a checkmark indicates that data is available to a user and an X indicates that data is not available to a user. In FIG. 6 checkboxes 612 and 618, respectively corresponding to ‘First Name’ and ‘Cell’ have checkmarks and checkboxes 614 and 616, respectively corresponding to ‘Last Name’ and ‘Email’ have Xs. The form portion 602, consequently shows text boxes for ‘First Name’ and ‘Cell’ only. A similar table may be displayed for the function adaptation information tab 615, including rows for ‘Add’, ‘Delete’ and ‘Edit’ with checkmarks in the rows corresponding to ‘Add’ and ‘Edit’ and an X in the row corresponding to ‘Delete’, This information is preferably displayed on a read-only basis for the user.

A user may review this information. An ‘Export’ button 620 may be activated to report the displayed adaptation information settings to the technical support group. If a user thinks it necessary an ‘Export all’ checkbox 622 may be checked to report all adaptation information to the technical support group. If it is felt that a problem exists and that the current configuration is causing the problem, this may be reported to the technical support group as a configuration change request rather than a executable application malfunction report. This in turn substantially reduces time spent in responding to a problem report because unnecessary troubleshooting is not performed.

If a problem is reported to a technical support group, before troubleshooting can be commenced, that group needs to know the identity and type of the executable application concerned and what configuration the user is operating under when the problem occurs. In such a case the adaptation information from the adaptability extract server 218 (FIG. 2) in the acquisition processor 108 (FIG. 1) is sent to the communication processor 114. The communications processor 114, in turn sends that information to the destination system 118, which in this case is the system used by the technical support group. In this case, the adaptation information in the standardized format, e.g. XML, may be sent to the destination system 118. Because the adaptation information is in the standardized format, e.g. XML, different tools for processing adaptation information from different executable application do not need to be kept and technical support personnel do not need to be adept at using the different tools. Instead, a single tool for the standardized format, e.g. XML, is maintained.

The communication of this information to the destination system 118 may take place automatically when a problem report is generated by a user. Alternatively, communication of this information to the destination system 118 may take place in response to a user command. Additional data describing the problem identified by the user may be communicated with the adaptation information to the destination system 118. The adaptation information communicated to the destination system 118 may include a desired configuration setting so that the technical support staff may analyze any differences between the configuration reported when the problem occurred and the desired configuration.

A UI form similar to the form 600 (FIG. 6) may be displayed on the remote display device 120 in the destination system 118 to aid the technical support personnel in analyzing the configuration in effect when a problem is reported by a user. The adaptation information available to the technical support personnel may further include the user ID, role and entity, and any and all adaptations associated with that user. The technical support personnel may then see what data is available for the form, what data is marked as unavailable to the user, and so forth. It is further possible to make the display 600 for technical support personnel read-write, so they may directly change the adaptation information for the user and possibly resolve the problem at that time. In cases where the problem is not directly related to the configuration under which the user is operating, the received adaptation information from the communication processor 114 (FIG. 1) may be used to reproduce the configuration/environment under which the user was operating when the problem occurred so that troubleshooting may be performed under that configuration/environment.

As described above, adaptation information is provided to the repositories 106 by users of an adaptation utility 216 (FIG. 2). The adaptation utility may also display a UI form similar to form 600 (FIG. 6). The form 600 displayed by the adaptability utility 216 is read-write so that the user may add, delete, and/or edit adaptation information.

A system as described above permits users of a processing system to understand the configuration of an executable application under which they are working so that unnecessary problem reports are not submitted, and to provide technical support personnel adaptation information in a standardized format, e.g. XML, in addition to data describing a problem, when a problem is reported, cutting down on troubleshooting time and requiring familiarity with fewer adaptation information analysis tools.

What is claimed is:

1. A system for providing information indicating change in configuration of an executable application, comprising:
an acquisition processor for acquiring adaptation information identifying change of a first configuration of a first executable application relative to a second configuration of said first executable application;
a data processor for associating an adaptation indicator representing a type of change in configuration of said first executable application identified by acquired adaptation information; and
a user interface for providing data representing a display image associated with said first configuration of said first executable application and including said adaptation indicator.

2. A system according to claim 1, wherein said acquisition processor acquires said adaptation information from a repository storing adaptation information of one or more different executable applications in a standardized adaptation information format.

3. A system according to claim 1, further comprising a communication processor for automatically communicating adaptation information, identifying change of said first configuration of said first executable application relative to said second configuration of said first executable application, together with data indicating a problem identified by a user concerning operation of said first configuration of said first executable application, to a destination system, in response to generation of a problem report.

4. A system according to claim 3, wherein said communication processor automatically communicates said configuration information identifying configuration settings of said first configuration of said first executable application to said destination system, in response to said generation of said problem report.

5. A system according to claim 1, further comprising a communication processor for automatically communicating configuration information identifying configuration settings of said first configuration of said first executable application to a destination system, in response to generation of a problem report.

6. A system according to claim 1, wherein said user interface provides data representing a display image indicating differences in configuration between said first and second configurations of said first executable application, in response to user command.

7. A system according to claim 6, wherein said user interface provides said data representing said display image indicating differences in configuration between said first and second configurations of said first executable application, in response to user selection of said adaptation indicator.

8. A system according to claim 7, further comprising a communication processor for communicating information indicating a desired configuration setting of said first executable application to a destination, said desired configuration setting being selected from said display image indicating differences in configuration in response to user command.

9. A system according to claim 1, including a communication processor for communicating information indicating a desired configuration setting of said first executable application to a destination system, in response to user command.

10. A system according to claim 1, wherein said adaptation information identifies change in configuration of said first executable application resulting from interaction of said second configuration of said first executable application with other executable applications exclusive of configuration changes made by a user during a current operational session of computer operation employing said first configuration of said first executable application.

11. A system according to claim 1, wherein said user interface displays a message indicating a category of change in configuration of said first executable application.

12. A system according to claim 11, wherein said category of change in configuration of said first executable application comprises at least one of, (a) change in configuration settings of a workflow, (b) change in configuration settings of a data processed in a workflow and (c) change in configuration settings of a function.

13. A system according to claim 11, wherein said user interface displays a message indicating a category of change in configuration of said first executable application via a selectable dialog menu indicating change in configuration settings of at least one of, (a) change in configuration settings of a workflow, (b) change in configuration settings of a data processed in a workflow and (c) change in configuration settings of a function.

14. A system according to claim 11, wherein said user interface displays an informational message indicating no workflow, data or function adaptations are in effect.

15. A system for providing information indicating change in configuration of an executable application, comprising:
at least one repository for storing adaptation information, identifying change of in configuration of one or more different executable applications relative to a first configuration, in a standardized adaptation information format;
an acquisition processor for acquiring adaptation information identifying change of a first configuration of a first executable application relative to a second configuration of said first executable application from said at least one repository; and
a user interface for providing data representing a display image associated with said first configuration of said first executable application and including an adaptation indicator indicating change in configuration of said first executable application relative to a second configuration of said first executable application.

16. A system according to claim 15, wherein said adaptation indicator indicates a type of change in configuration of said first executable application.
